(19) United States
(12) Patent Application Publication
(10) Pub. No.: US 2009/0202029 A1
(43) Pub. Date: Aug. 13, 2009

(54) OPTIMIZED PRIMARY SYNCHRONIZATION SEQUENCES FOR DEDICATED MULTIMEDIA BROADCAST/ MULTICAST SERVICE

(75) Inventors: Shahrokh Nayeb Nazar, Sainte-Julie (CA); Afshin Haghighat, Ile-Bizard (CA); Allan Y. Tsai, Boonton, NJ (US); Guodong Zhang, Syosset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/366,864

(22) Filed: Feb. 6, 2009

Related U.S. Application Data
(60) Provisional application No. 61/027,003, filed on Feb. 7, 2008.

(51) Int. Cl. H04L 7/04

(52) U.S. Cl. 375/362

(57) ABSTRACT

A method optimizes a selection of primary synchronization channel (P-SCH) sequences from an available set of P-SCH indices for a dedicated Multimedia Broadcast/Multicast Service (MBMS). The criteria for selecting P-SCH indices include coprimeness, frequency offset sensitivity, multipath sensitivity, cross-correlation property in the time domain, auto-correlation property in the time domain and computation complexity at the receiver.

### CROSS REFERENCE TO RELATED APPLICATION(S)

This application claims the benefit of U.S. Provisional Patent Application No. 61/027,003, filed on Feb. 7, 2008, which is incorporated by reference as if fully set forth.

### FIELD OF INVENTION

This application is related to wireless communications.

### BACKGROUND

With increasing use of high bandwidth applications in Third Generation Partnership Project (3GPP) mobile systems, especially with a large number of users receiving the same high data rate services, efficient information distribution is essential. Broadcast and multicast are techniques to decrease the amount of data within the network and use resources more efficiently. Recently, the Multimedia Broadcast/Multicast Service (MBMS) has been defined for the 3GPP systems to provide such capabilities. The MBMS is a unidirectional point-to-multipoint service in which data is transmitted from a single source entity to a group of users in a specific area.

FIG. 1 illustrates a conventional packet-optimized radio access network, in this case a UMTS Terrestrial Radio Access Network (UTRAN). The UTRAN has one or more radio network controllers (RNCs) 104 and base stations 102, referred to as Node-Bs or evolved Node-Bs (eNBs) by 3GPP, which collectively provide for the geographic coverage for wireless communications with WTRUs 100, referred to as user equipments (UEs) by 3GPP. The geographic coverage area of a Node-B 102 is referred to as a cell. The UTRAN is connected to a core network (CN) 106.

In the evolved UMTS terrestrial radio access network (E-UTRAN), MBMS can be provided on a frequency layer dedicated to MBMS (MBMS-dedicated cell) or on a frequency layer shared with non-MBMS services (i.e. Unicast/MBMS mixed cell). Moreover, MBMS transmissions may be performed in two ways: a single-cell transmission and a multi-cell transmission. The latter is known as Multicast Broadcast Single Frequency Network (MBSFN) in Long Term Evolution (LTE) specifications. In MBSFN, the synchronous transmission from multiple cells enables over-the-air combining which significantly improves the signal to interference noise ratio SINR at the wireless transmitter receiver unit (WTRU) compared to unicast operation.

Although the LTE specification for MBSFN is in its early stages, a number of companies are suggesting that in the case of MBMS-dedicated transmissions all data within a frame including synchronization signals has to be MBSFN-transmitted to prevent significant resource wastage in high bandwidth cells. It is worthwhile noting that under the current working assumptions in a mixed unicast/MBMS scenario, subframes 0 and 5 which also contain synchronization signals are reserved for unicast data transmission. However, the point is that for a MBMS-dedicated transmission there should not be any restriction on MBSFN data transmission in any subframe.

A problem associated with enabling MBSFN on all data for MBMS-dedicated transmission is that during the initial synchronization, the WTRU may have no knowledge about the transmission scenario, i.e. whether it is a unicast/mixed carrier or dedicated MBMS carrier. This problem may be resolved by adding an additional primary synchronization channel (P-SCH) sequence exclusively for this purpose. Thus, the WTRU would be able to use the three already defined P-SCH sequences for unicast cell search and the additional sequence for searching dedicated MBMS carriers. Based on the current LTE specification, the three different sequences used for the primary synchronization in a mixed unicast/MBMS cell are defined based on the frequency-domain Zadoff-Chu sequence according to the following equation:

$${d}_{u} ( n ) = \{ \begin{matrix}{e}^{- j \frac{π un ( n + 1 )}{63}} & n = 0 , 1 , … , 30 \\ {e}^{- j \frac{π un ( n + 1 ) ( n + 2 )}{63}} & n = 31 , 32 , … 61.\end{matrix}$$

The current agreement calls for Zadoff-Chu sequences with root sequence indices u∈{25,29,34}.

But merely adding an additional P-SCH sequence may introduce some additional issues such as: (i) reducing the performance of the unicast cell search operation, (ii) negatively impacting the initial cell search timing due to an extra cross-correlation operation; and (iii) higher computational complexity from implementation point of view. Thus, an efficient method for optimizing the selection of these P-SCH sequences is highly desirable.

### SUMMARY

The present application is a method and apparatus for optimizing the selection of primary synchronization channel (P-SCH) sequences from the available set of P-SCHs for a dedicated Multimedia Broadcast/Multicast Service (MBMS).

Criteria for selecting P-SCH sequences may include criteria such as: coprimeness of the sequence indices; frequency offset sensitivity of the sequences; multipath sensitivity of the sequences; auto-correlation properties of the sequences in the time domain; cross-correlation properties between the sequences in the time domain; and computation complexity of the sequences at the receiver

### BRIEF DESCRIPTION OF THE DRAWING

A more detailed understanding may be had from the following description of the embodiments, given by way of example and to be understood in conjunction with the accompanying drawing wherein:

FIG. 1 is a schematic block diagram illustrating a conventional packet-optimized radio access network, such as a UTRAN;

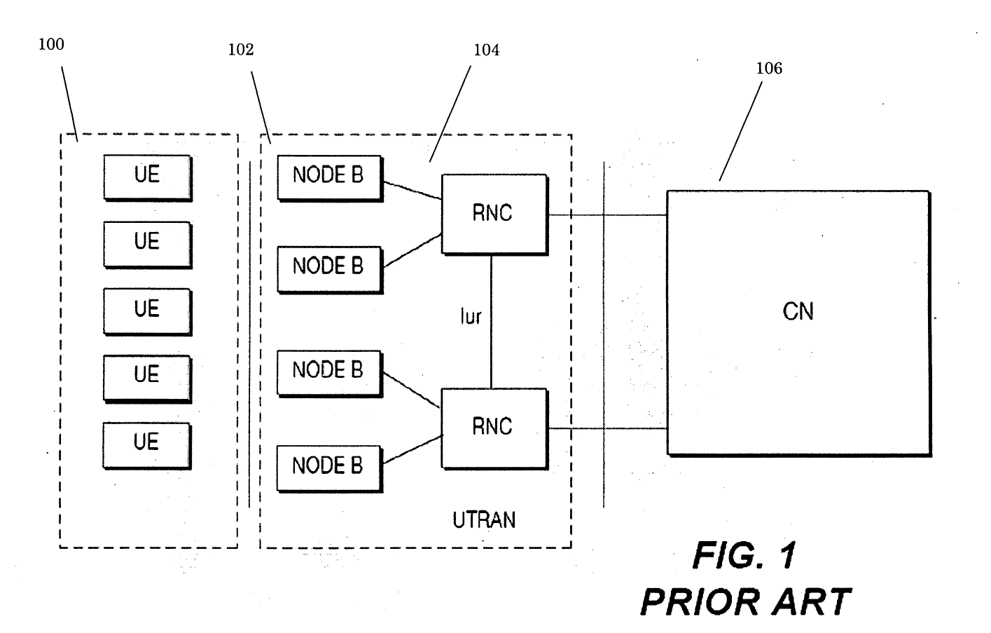

FIG. 2 is a graph illustrating the Frequency Offset Sensitivity for each root index presented in Table 1;

FIG. 3 is a schematic block diagram illustrating certain features of an example WTRU according to the present application;

FIG. 4 is a flowchart illustrating an example method for selecting primary synchronization sequences for a dedicated multimedia broadcast/ multicast service (MBMS).

### DETAILED DESCRIPTION OF THE EMBODIMENTS

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

In example embodiments of the present application described below, primary synchronization channel (P-SCH) sequences are selected from an initial set of 63-length Zadoff-Chu (ZC) root-index candidates. The specific choice of 63-length ZC root sequences as the P-SCH sequences, herein, is for convenience and convention; however, this choice is not intended as limited and it is contemplated that other families of sequences may be used instead.

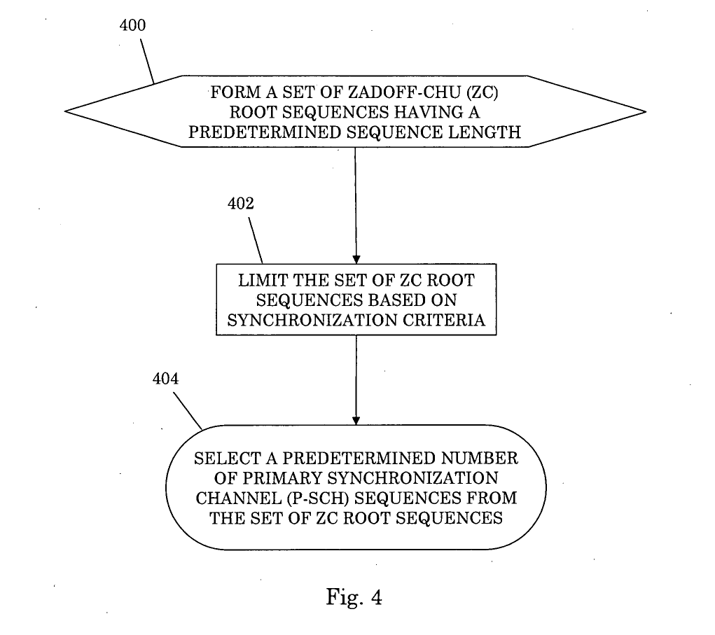

As illustrated in FIG. 4, example methods of selecting P-SCH sequences according to the present application begin with forming the initial set of ZC root sequences, which have a predetermined length, step 400, e.g., 63 in the example embodiments below.

The initial set of ZC root sequences is limited based on one or more synchronization criteria. One criterion of the example P-SCH sequence selection processes of the present application involves reducing the choices from an initial set of ZC root sequences according to a coprimeness criterion. ZC root sequences having indices that are relatively prime with respect to the sequence length are chosen. These indices for an example set of 63 length sequences are shown in Table 1. As shown in Table 1, there are 35 available candidates that are co-prime with 63.

TABLE 1

| | | | | | | | | | | | | | | | | | |
|---|---|---|---|---|---|---|---|---|---|---|---|---|---|---|---|---|---|
| 2 | 4 | 5 | 8 | 10 | 11 | 13 | 16 | 17 | 19 | 20 | 22 | 23 | 25 | 26 | 29 | 31 | 32 |
| 34 | 37 | 38 | 40 | 41 | 43 | 44 | 46 | 47 | 50 | 52 | 53 | 55 | 58 | 59 | 61 | 62 | |

Robustness against the frequency offset is another criterion, because this factor plays a role for the initial cell search. A frequency offset may result in creation of undesired peaks in the auto-correlation profile R_{d} that may cause some ambiguity for the initial cell search. The frequency offset sensitivity is defined as:

$$Frequency Offset Sensitivity = \frac{Max ( {R}_{d} )}{Max Sidelobes of {R}_{d}} .$$

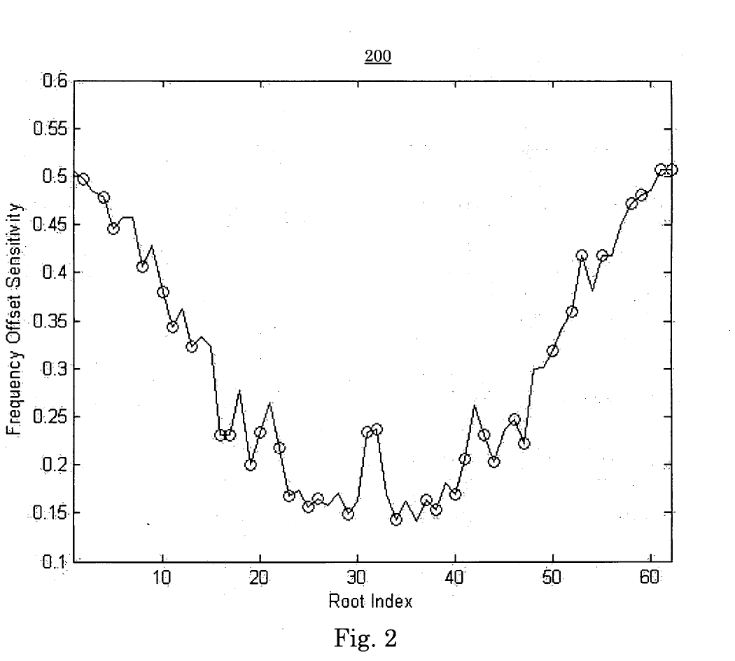

Assuming a frequency offset of 5 ppm, FIG. 2 shows the Frequency Offset Sensitivity for each root index presented in Table 1.

As can be seen from frequency offset sensitivity graph 200 summarized in FIG. 2, the root indices between 16 and 47 are relatively robust against frequency offset. Accordingly, the set of ZC root sequences from which the P-SCH sequences are desirably selected may be further limited by selecting ZC root sequences that demonstrate a frequency offset sensitivity of less than 0.25. These the ZC root sequence indices of such sequences are marked in the Table 2.

TABLE 2

| | FO |
|---|---|
| Root index | sensitivity |
| 2 | 0.4970 |
| 4 | 0.4773 |
| 5 | 0.4454 |
| 8 | 0.4059 |
| 10 | 0.3804 |
| 11 | 0.3438 |
| 13 | 0.3223 |
| 16 | 0.2313 |
| 17 | 0.2312 |
| 19 | 0.2004 |
| 20 | 0.2336 |
| 22 | 0.2175 |
| 23 | 0.1679 |
| 25 | 0.1565 |
| 26 | 0.1645 |
| 29 | 0.1484 |
| 31 | 0.2337 |
| 32 | 0.2361 |
| 34 | 0.1434 |
| 37 | 0.1634 |
| 38 | 0.1531 |
| 40 | 0.1688 |
| 41 | 0.2055 |
| 43 | 0.2309 |
| 44 | 0.2024 |
| 46 | 0.2470 |
| 47 | 0.2217 |
| 50 | 0.3189 |
| 52 | 0.3600 |
| 53 | 0.4182 |
| 55 | 0.4177 |
| 58 | 0.4715 |
| 59 | 0.4811 |
| 61 | 0.5067 |
| 62 | 0.5077 |

In multipath environments, due to the time-frequency ambiguity, a delay shift would have the same effect as a frequency offset for a ZC-based design. This means that a timing offset caused by the multipath can be mistaken as a frequency offset, which in turn, may increase the probability of false timing detection. This potential problem may be addressed by selecting a ZC root sequence with a root sequence index that is larger than the maximum expected delay spread of the channel. Therefore, by assuming the maximum delay spread of the channel to be in the range of the extended cyclic prefix (CP) length of the channel (i.e. approximately 16 μsec in 3GPP telecommunication systems), the ZC root sequence may be limited to the subset having root sequence indices: {16,17, . . . ,47}. It is noted that this limitation is satisfied by using the previous limiting criteria, which means that the limitation of the ZC root sequences on the basis of multipath time-frequency ambiguity does not further limit the set of sequences over the criteria of robustness.

Another possible limiting criterion is based on the auto-correlation profile of the ZC root sequences. Examination of ZC root sequences reveals that only the root sequences having lower and higher ZC root indices, compared to the sequence length (e.g., 2, 3, . . . or . . . 61, 62) exhibit the lowest auto-correlation side-lobes. However, the ZC root sequences having those root indices may be desirably removed from the list of candidate ZC root sequences based on the previously described limiting criteria involving Frequency Offset Sensitivity and multipath time-frequency ambiguity. Therefore, the desire that the selected P-SCH sequences have good auto-correlation profile conflicts with the desires that these P-SCH sequences also have low sensitivity to the frequency offset and the multipath time-frequency ambiguity. However, since the latter two considerations have a more destructive effect on the initial cell search than the auto-correlation profile, auto-correlation profile criterion may desirably be applied only as a relative measure between the candidate ZC root sequences that meet these latter two criteria.

After the set of ZC root sequences has been limited by one or more of the previously described synchronization criteria, the predetermined number of P-SCH sequences is selected from the set of ZC root sequences that remain, step 404. One example procedure for making this selection involves studying the cross-correlation profiles of pairs of the remaining ZC root sequences. The procedure may include an empirical relative coprimeness analysis. In this example empirical relative coprimeness analysis, whether the cross-correlation of the two frequency-domain ZC root sequences in the time-domain results in a ZC root sequence may be analyzed by evaluating a function defined as:

$$f ( {M}_{1} , {M}_{2} ) = \frac{63}{{M}_{2} - {M}_{1}} ,$$

where M₁ and M₂ are the ZC root indices of the two frequency-domain ZC root sequences being analyzed.

TABLE 3

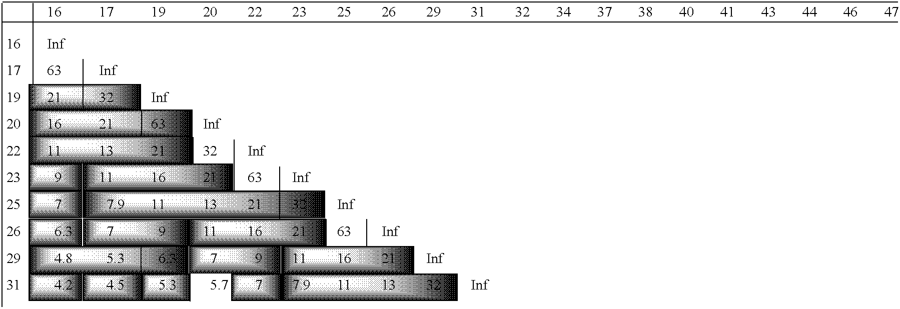

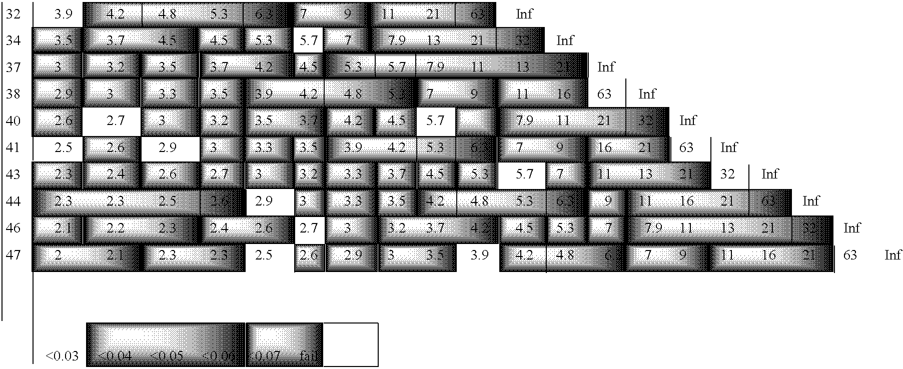

Table 3, shows the value of this evaluated function for all possible pairs of root sequence indices. For example, for M₁=16 and M₂=19, f(M₁,M₂)=21, which means that the cross-correlation of ZC root sequences with root indices {16, 19} will result in a ZC root sequence of length 21 (i.e., 3 times repetition in the time-domain). Based on empirical studies, if the value of the computed function belongs to the subset of {9/4, 7/3, 3, 7/2, 9/2, 7, 9}, the corresponding pair of ZC root sequences fails the relative coprimeness criterion. Subsequently, those pairs that fail this relative coprimeness criterion may be identified and removed from the potential list of candidate pairs.

Additionally, the peak of the cross-correlation function may be examined. In Table 3, each pair is classified according to the peak of their cross-correlation profile. The ZC root sequence combinations having the best cross-correlation property are those with low cross-correlation peaks. Therefore, a maximum value for the cross-correlation peak of selected pairs, e.g. 0.03, may be set.

Another optimization criterion is to minimize the numerical complexity at the receiver from the implementation point of view. For this purpose, it may be desired for the third and forth selected ZC root sequences be complex conjugates of the first and second selected ZC root sequences, respectively. More specifically, defining {M₁,M₂,M₃,M₄} as the set of ZC root indices of the ZC root sequences chosen from the limited list of the candidate ZC root sequences, this criterion means that it may be desirable for:

M₃=63−M₁

M₄=63−M₂

According to this example selection criterion, 10 pairs of ZC root sequences may be identified within the set of ZC root sequences. These pairs are marked in Table 3 with bold borders and represent a diagonal set of blocks. It is noted that the complexity reduction for this scenario may be attributed to the correlation between the second and third (the first and fourth) ZC root sequences may be obtained from the correlation of the first and third (the second and fourth) ZC root sequences. Thus, two correlators may be used to support the dedicated MBMS scheme, which is the same number used for unicast schemes.

The criteria explained above result in a number of candidate sets of ZC root sequences for the primary synchronization sequences in a dedicated MBMS system. The results of the application of these example selection criteria are summarized in Table 4. Specifically, any combination of two pairs of ZC root sequences who root indices are marked with “x” in Table 4 is a potential candidate set of P-SCH sequences. As an example, the set of ZC root sequences having root indices {29, 31, 34, 32} may be chosen. Table 4 shows that each set of two ZC root sequences has a desirable cross-correlation profile; and that the two pairs of ZC root sequences having the root indices {29,34} and {31,32} each form complex conjugated sequence pairs.

TABLE 4

| | (31, 32) | (29, 34) | (26, 37) | (25, 38) | (23, 40) | (22, 41) | (20, 43) | (19, 44) | (17, 46) | (16, 47) |
|---|---|---|---|---|---|---|---|---|---|---|
| (31, 32) | | | | | | | | | | |
| (29, 34) | x | | | | | | | | | |
| (26, 37) | x | x | | | | | | | | |
| (25, 38) | | | x | | | | | | | |
| (23, 40) | | x | | x | | | | | | |
| (22, 41) | | | x | x | | | | | | |
| (20, 43) | x | | x | | x | | | | | |
| (19, 44) | x | x | | x | | x | x | | | |
| (17, 46) | | x | | | x | x | x | | | |
| (16, 47) | x | | | | | x | | | x | |

Applicants note one additional set of ZC root sequences that may be desirable to use. This is the set formed of the two pairs of ZC root sequences having the root indices {29,34} and {25,38}. Although this set of ZC root sequences, {25,29,34,38}, does not produce cross-correlation profiles that are as desirable as those produced by the sets identified in Table 4, this set does have the advantage of including the three ZC root sequences used for initial synchronization in current unicast 3GPP telecommunication systems, i.e. those having the root indices 25, 29, and 34.

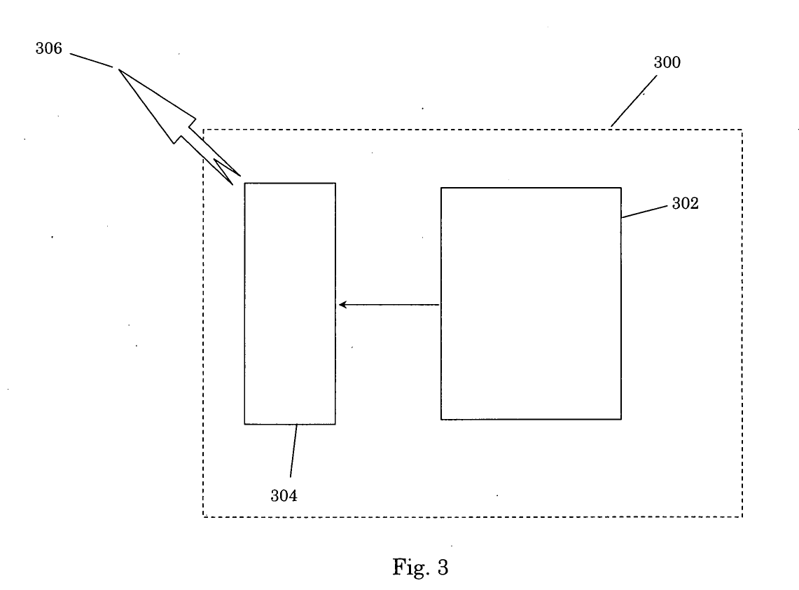

FIG. 3 illustrates example WTRU 300 that may be configured to select primary synchronization sequences for a dedicated MBMS. WTRU 300 includes: P-SCH sequence generator 302; and transmitter 304 coupled to P-SCH sequence generator 302.

P-SCH sequence generator 302 is configured to generate a predetermined number of P-SCH sequences. These P-SCH sequences are desirably selected from a set of Zadoff-Chu (ZC) root sequences having a predetermined sequence length according to one of the example methods described above with reference to FIG. 4.

Transmitter 304 is configured to transmit the P-SCH sequences on P-SCH 306.

Applicants note that P-SCH sequence generator 302 and/or transmitter 304 may include processors and/or other electronic modules and circuitry to perform the desired functions of these elements.

Although the features and elements are described in embodiments in particular combinations, each feature or element can be used alone without the other features and elements of the embodiments or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for selecting primary synchronization sequences for a dedicated multimedia broadcast/ multicast service (MBMS) comprising:
selecting a predetermined number of primary synchronization channel (P-SCH) sequences from a set of Zadoff-Chu (ZC) root sequences having a predetermined sequence length.

2. The method of claim 1, further comprising:
limiting the set of ZC root sequences to ZC root sequences having ZC root sequence indices that are coprime with respect to the predetermined sequence length.

3. The method of claim 1, further comprising:
limiting the set of ZC root sequences to ZC root sequences that demonstrate a frequency offset sensitivity less than a predetermined threshold.

4. The method of claim 1, further comprising:
limiting the set of ZC root sequences to ZC root sequences having ZC root indices that are larger than at least one of:
a maximum delay spread of a channel to be synchronized; or an extended cyclic prefix (CP) length of a channel to be synchronized.

5. The method of claim 1, wherein selecting the predetermined number of P-SCH sequences from the set of ZC root sequences includes:
comparing pairs of ZC root indices of ZC root sequences in the set of ZC root sequences; and
forming at least one candidate subset of ZC root sequences such that each candidate subset:
has the predetermined number of ZC root sequences; and
each pair of ZC root indices of ZC root sequences in the candidate subset meets an empirical relative coprimeness criterion.

6. The method of claim 5, wherein:
the predetermined sequence length of the set of ZC root sequences is 63;
a relative coprimeness ratio.
$$f ( {M}_{a} , {M}_{b} ) = \frac{63}{{M}_{b} - {M}_{a}}$$
(where Mₐ and M_{b} are ZC root indices), is calculated for each pair of ZC root indices of ZC root sequences in a candidate subset; and
the empirical relative coprimeness criterion is met for the candidate subset, if the relative coprimeness ratio of every pair of ZC root indices of ZC root sequences in the candidate subset is not a member of the set {9/4, 7/3, 3, 7/2, 9/2, 7, 9}.

7. The method of claim 5, wherein selecting the predetermined number of P-SCH sequences from the set of ZC root sequences further includes one of:
selecting one of the at least one candidate subset that includes at least one pair of complex conjugate ZC root sequences; or selecting one of the at least one candidate subset such that the selected candidate subset minimizes numerical complexity during synchronization.

8. The method of claim 1, wherein selecting the predetermined number of P-SCH sequences from the set of ZC root sequences includes:
calculating cross-correlation functions of pairs of ZC root sequences in the set of ZC root sequences; and
forming at least one candidate subset of ZC root sequences such that each candidate subset:
has the predetermined number of ZC root sequences; and
each pair of ZC root sequences in the candidate subset has a cross-correlation peak less than a predetermined value.

9. The method of claim 8, wherein the predetermined value is 0.03.

10. The method of claim 8, wherein selecting the predetermined number of P-SCH sequences from the set of ZC root sequences further includes one of:
selecting one of the at least one candidate subset that includes at least one pair of complex conjugate ZC root sequences; or selecting one of the at least one candidate subset such that the selected candidate subset minimizes numerical complexity during synchronization.

11. The method of claim 1, further comprising:
limiting the set of ZC root sequences to ZC root sequences that exhibit lower than average auto-correlation side-lobes.

12. The method of claim 1, wherein:
the predetermined sequence length of the set of ZC root sequences is 63;
the predetermined number of P-SCH sequences is four; and
the selected P-SCH sequences are one of the sets of four ZC root sequences having ZC root indices: {16, 17, 46, 47}; {16, 22, 41, 47}; {16, 31, 32, 47}; {17, 20, 43, 46}; {17, 22, 41, 46}; {17, 23, 40, 46}; {17, 29, 34, 46}; {19, 20, 43, 44}; {19, 22, 41, 44}; {19, 25, 38, 44}; {19, 29, 34, 44}; {19, 31, 32, 44}; {20, 23, 40, 43}; {20, 26, 37, 43}; {20, 31, 32, 43}; {22, 25, 38, 41}; {22, 26, 37, 41}; {23, 25, 38, 40}; {23, 29, 34, 40}; {25, 26, 37, 38}; {25, 29, 34, 38}; {26, 29, 34, 37}; {26, 31, 32, 37}; or {29, 31, 32, 34}.

13. A wireless transmit/receive unit (WTRU) configured to select primary synchronization sequences for a dedicated multimedia broadcast/ multicast service (MBMS), the WTRU comprising:
a primary synchronization channel (P-SCH) sequence generator configured to generate a predetermined number of P-SCH sequences, the P-SCH sequences selected from a set of Zadoff-Chu (ZC) root sequences having a predetermined sequence length; and
a transmitter coupled to the P-SCH sequence generator to transmit the predetermined number of P-SCH sequences on the P-SCH.

14. The WTRU of claim 13, wherein the set of ZC root sequences from which the P-SCH sequences are selected is limited to at least one of:
ZC root sequences having ZC root sequence indices that are coprime with respect to the predetermined sequence length;
ZC root sequences that demonstrate a frequency offset sensitivity less than a predetermined threshold;
ZC root sequences having ZC root indices that are larger than at least one of:
a maximum delay spread of a channel to be synchronized; or
an extended cyclic prefix (CP) length of a channel to be synchronized; or
ZC root sequences that exhibit lower than average auto-correlation side-lobes.

15. The WTRU of claim 13, wherein each pair of selected P-SCH sequences meets an empirical relative coprimeness criterion.

16. The WTRU of claim 15, wherein the predetermined number of P-SCH sequences includes at least one pair of complex conjugate ZC root sequences.

17. The WTRU of claim 13, wherein each pair of ZC root sequences in the predetermined number of selected P-SCH sequences has a cross-correlation peak less than a predetermined value.

18. The WTRU of claim 17, wherein the predetermined value is 0.03.

19. The WTRU of claim 17, wherein the predetermined number of P-SCH sequences includes at least one pair of complex conjugate ZC root sequences.

20. The WTRU of claim 1, wherein:
the predetermined sequence length of the set of ZC root sequences is 63;
the predetermined number of P-SCH sequences is four; and
the selected P-SCH sequences are one of the sets of four ZC root sequences having ZC root indices: {16, 17, 46, 47}; {16, 22, 41, 47}; {16, 31, 32, 47}; {17, 20, 43, 46}; {17, 22, 41, 46}; {17, 23, 40, 46}; {17, 29, 34, 46}; {19, 20, 43, 44}; {19, 22, 41, 44}; {19, 25 38, 44}; {19, 29, 34, 44}; {19, 31, 32, 44}; {20, 23, 40, 43}; {20, 26, 37, 43}; {20, 31, 32, 43}; {22, 25, 38, 41}; {22, 26, 37, 41}; {23, 25, 38, 40}; {23, 29, 34, 40}; {25, 26, 37, 38}; {25, 29, 34, 38}; {26, 29, 34, 37}; {26, 31, 32, 37}; or {29, 31, 32, 34}.
